(19) United States
(12) Patent Application Publication
(10) Pub. No.: US 2008/0119176 A1
(43) Pub. Date: May 22, 2008

(54) Method for sharing data by instant message and electronic apparatus thereof

(76) Inventors: Liang Chen Chen, Hsichih (TW); Ya-Chin Cheng, Hsichih (TW); Jen Chiang Rau, Hsichih (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/798,945

(22) Filed: May 18, 2007

(30) Foreign Application Priority Data
Nov. 22, 2006 (TW) 095143170

(51) Int. Cl. H04M 3/42; H04Q 7/20

(52) U.S. Cl. 455/414.2; 455/456.1

(57) ABSTRACT

The present invention discloses an apparatus and a method of sharing data by an instant message. The electronic apparatus sends user ID information to an instant message platform through an instant message program to complete a logon procedure, such that the electronic apparatus can transmit position information or multimedia stream to a remote host logged on the instant message platform through an instant message network. A visual operation interface of the instant message program displays the positions of the electronic apparatus and a plurality of remote hosts on a map. Users can select one of the remote hosts as a target position for the navigation through the visual operation interface. The electronic apparatus sends a playing multimedia data in a stream format to at least one remote host through the instant message network, and plays the multimedia data at the remote host to achieve the instant multimedia sharing effect.

### BACKGROUND OF THE INVENTION

1. Field of the Invention

The present invention relates to an apparatus and a method of sharing data by an instant message, and more particularly to an apparatus and a method of sharing position information or multimedia stream by an instant message.

2. Description of the Related Art

At present, the application of a global positioning system (GPS) becomes increasingly popular, and many people rely on the global positioning system (GPS) to plan their driving routes and navigation paths to prevent getting lost and avoid traffics. However, the operating interface of a traditional global positioning system (GPS) is very complicated and generally requires a complicated operating procedure to complete setting a destination and a navigation path, and thus it takes some time for users to learn the operating procedure. In a traditional global positioning system (GPS), if a user needs to navigate an address other than those preinstalled into the system, such as a place for meeting a friend, and thus it is necessary to know the address where the friend is currently situated, and then the user has to input the address into the global positioning system (GPS), such that the global positioning system (GPS) can plan a route, and the aforementioned procedure requires the user to go through a series of steps. If the user is driving a car and needs to carry out these steps, it is definitely a challenge to the user. Therefore, finding a way of simplifying the operation procedure of a global positioning system (GPS) demands immediate attentions and feasible solutions.

Instant message software including MSN, or Skype has become very popular, and most people have experience of using instant messages to talk with a friend at a remote end. In general, many people have a logon account of the instant message software and are familiar with the operating interface of the instant message software already.

In addition, a user also can send a file to a friend at a remote end through the instant message software. However, the friend at a remote end must receive a complete file before the file can be opened or played, and users cannot share a certain pieces of the file with their friends at a remote end.

In view of shortcomings of the prior art, the inventor of the present invention based on years of experience in the related industry to conduct extensive researches and experiments, and finally developed an apparatus and a method of sharing data by an instant message in accordance with the present invention to overcome the aforementioned shortcomings.

### SUMMARY OF THE INVENTION

Therefore, it is a primary objective of the present invention to provide an apparatus and a method of sharing data by an instant message for improving the convenience of sharing data.

To achieve the foregoing objective, the invention provides a method of sharing position information between an electronic apparatus and a remote host, and the method comprises the steps of: transmitting a user ID information to an instant message platform through an instant message (IM) program to complete a logon procedure; transmitting data with a remote host logged on the instant message platform through an instant message network; obtaining a position information of the remote host, and transmitting a position information of an electronic apparatus of the user ID information through the instant message network to the remote host; receiving a position information of the remote host through the instant message network; and displaying the position information of a local host and the remote host on an electronic map screen.

The present invention further provides an electronic apparatus that comprises a global positioning module, a processing unit and a display unit. The global positioning module is used to provide a position information of the electronic apparatus, and the processing unit executes an instant message program, and transmits a user ID information of the electronic apparatus to an instant message platform to complete a logon procedure. The position information and instant text messages are transmitted with a remote host logged on the instant message platform through the instant message network. The display unit is provided for displaying a visual operation interface of the instant message program, and the visual operation interface includes a text input area and a map display area, and the display unit displays the position information of the electronic apparatus and remote host on the map display area.

A user also can select a remote host from the map display area as a destination, and the processing unit calculates a planned route between an electronic apparatus and the remote host, and generates a navigation message based on the position information of the electronic apparatus in the planned route, so that the user can continue gaining experience on operating the instant message program and use a simple and easy way to complete the setup of the route navigation.

The present invention further provides a method of sharing multimedia data between an electronic apparatus and a remote host, and the method comprises the steps of: playing a multimedia file; transmitting a user ID information into an instant message platform to complete a logon procedure through an instant message program; transmitting data with a remote host logged on the instant message platform through an instant message network; receiving a trigger signal; converting data of the multimedia file at the time after a trigger signal shows up into a multimedia stream; transmitting the multimedia stream to the remote host through the instant message network; and playing the multimedia stream at the remote host.

The present invention further provides an electronic apparatus that comprises a multimedia playing unit, a processing unit and a stream conversion unit. The processing unit is provided for executing an instant message program and transmitting a user ID information of the electronic apparatus to an instant message platform to complete a logon procedure, and data is transmitted with a remote host logged on the instant message platform through an instant message network. If the multimedia playing unit is playing a multimedia file and the processing unit has received a trigger signal, then the stream conversion unit will convert a data of the multimedia file at the time after a trigger signal shows up into a multimedia stream, and the multimedia stream is transmitted to the remote host through the instant message network.

To make it easier for our examiner to understand the technical characteristics and effects of the present invention, we use preferred embodiments together with the attached drawings for the detailed description of the present invention.

### BRIEF DESCRIPTION OF THE DRAWINGS

FIG. 1 is a block diagram of an apparatus provided for a user to share position information with a friend at a remote end by instant message in accordance with a preferred embodiment of the present invention;

FIG. 2 is a schematic view of a visual operation interface of an instant message program in accordance with the present invention;

FIG. 3 is a flow chart of a method of sharing position information between a user and a friend at a remote end by instant message in accordance with a preferred embodiment of the present invention;

FIG. 4 is a block diagram of an apparatus provided for a user to share multimedia data with a friend at a remote end by instant message in accordance with a preferred embodiment of the present invention;

FIG. 5 is a schematic view of a video file in accordance with the present invention; and

FIG. 6 is a flow chart of a method of sharing multimedia data with a friend at a remote end by instant message in accordance with a preferred embodiment of the present invention.

### DETAILED DESCRIPTION OF THE PREFERRED EMBODIMENTS

The method of sharing data by instant message and its electronic apparatus in accordance with the present invention will now be described in more detail hereinafter with reference to the accompanying drawings that show various embodiments of the invention, in which the same element illustrated in the following preferred embodiments is represented by the same numeral for simplicity.

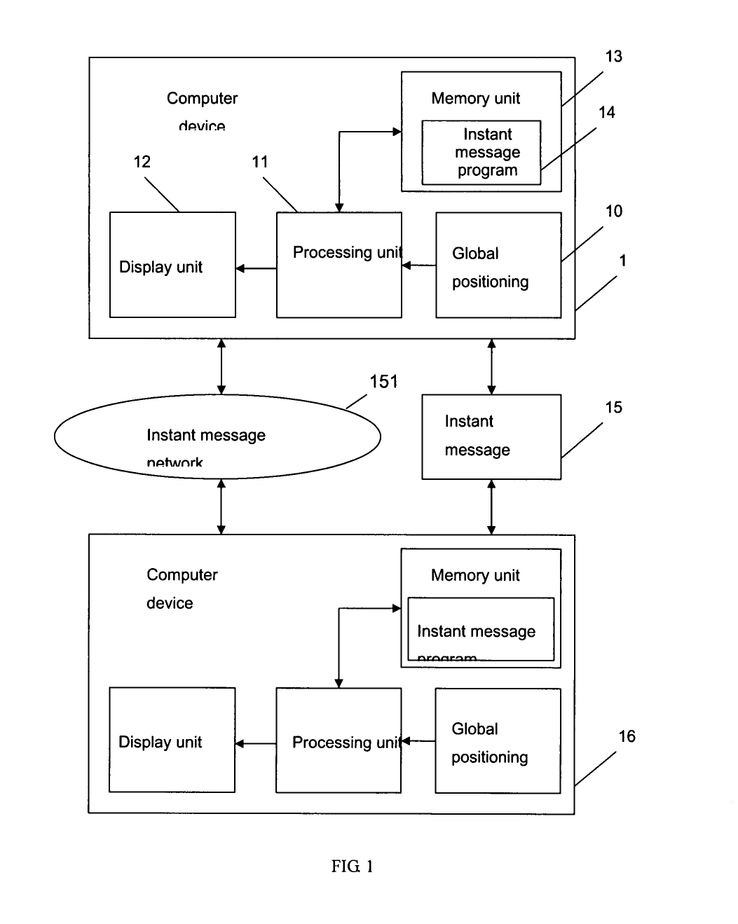

Referring to FIG. 1 for a block diagram of an electronic apparatus provided for a user to share position information with a friend at a remote end by an instant message in accordance with a preferred embodiment of the present invention, a computer device 1 of the embodiment comprises a global positioning module (GPS) 10, a processing unit 11, a display unit 12 and a memory unit 13. The global positioning module 10 is provided for receiving at least four satellite positioning signals to calculate the position information of the computer device 1. The processing unit 11 is provided for executing an instant message program 14 stored in the memory unit 13, and transmitting a user ID information to an instant message platform 15 to complete a logon procedure. After the logon is completed, the instant message program 14 stores the current network connection related data including an IP address or a port ID of the computer device 1 in the instant message platform 15, and the data is provided and read by the remote computer device. Similarly, if a friend of the user is using a computer device 16 logged on the instant message platform 15, the computer device 1 will perform a node-to-node connection in the instant message network 151 to transmit position information and instant text messages according to the network connection related data of the computer device 16 stored in the instant message platform 15.

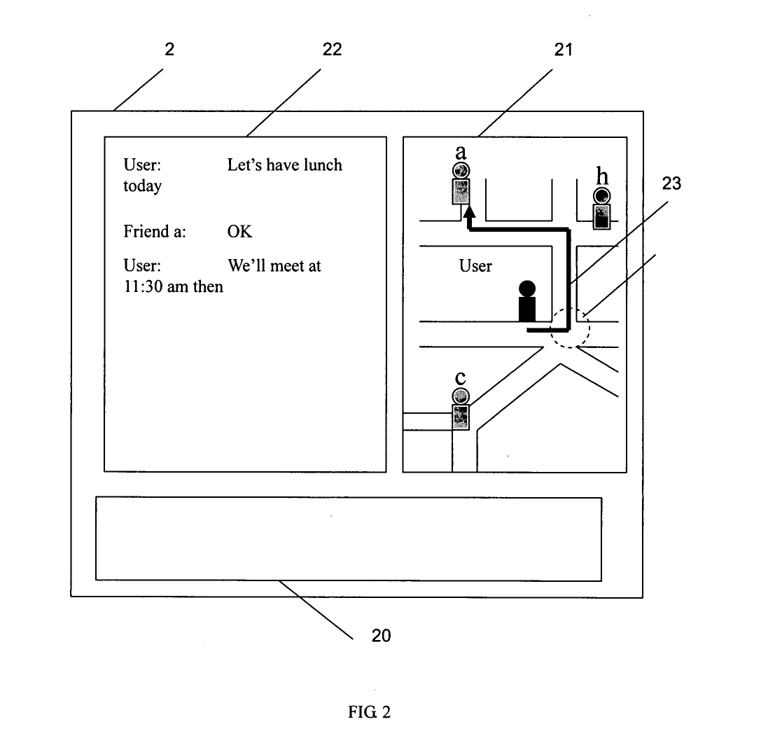

The display unit 12 is provided for displaying a visual operation interface 2 of the instant message program 14 as shown in FIG. 2, and the visual operation interface 2 includes a text input area 20, a map display area 21 and a history message display area 22, and the display unit 12 displays the position information of the computer device 1 at the map display area 21 and the position information of the computer operated by a friend within a predetermined range at a distance from the user. In FIG. 2, the friend a, friend c and friend h of the user have logged on the instant message platform 15, and the global positioning modules have installed to the operating computer devices, and thus the friend a, friend c and friend h of the user can transmit position information with each other, and display the position information at the map display area 21. Users can adjust the display scale of the map display area 21 according to actual requirements.

The computer device 1 can include a navigation module, if needed, for calculating a planned route between a user and a friend at a remote end to carry out navigation, and the planned route is displayed at the map display area. F or instance, in FIG. 2, a user inputs texts at the text input area 20, and makes a lunch appointment with a friend at 11:30 am through the instant text message, and then the user can touch the icon of friend a in the map display area 21, and the navigation module will plan a better route 23 according to the user's current position information, the friend's current position information and the map database to, and display the better route 23 in a graphic mode at the map display area or all of the names of the roads along the better route 23 in a text mode. The navigation module will generate a navigation message, according to the route 23 and the position information of the computer device 1, to guide a user to go to the position of friend a. Such the navigation message can include a left turn message, a right turn message, a front gate reminding message, a speed limit reminder message or a police detector position reminding message. In FIG. 2, if the navigation module determines that the position of the user has approached a turning corner position 231, a left turn message will be generated and displayed on the display unit 12 or outputted by a speaker of the computer device to remind the user.

In the foregoing process, a user can continue gaining experience on operating the instant message program and use a simple and easy way to complete the setup of a route navigation.

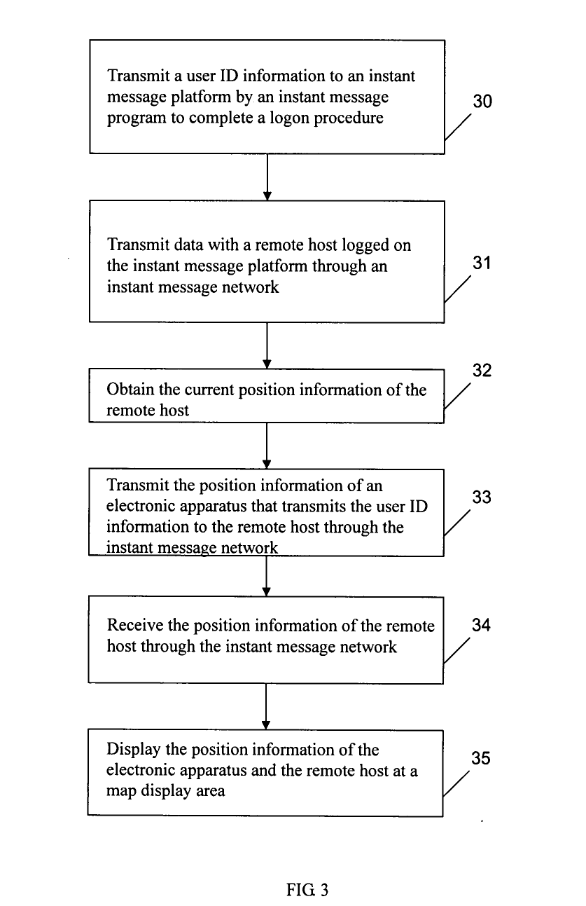

Referring to FIG. 3 for a flow chart of a method of sharing position information between an electronic apparatus and a remote host in accordance with a preferred embodiment of the present invention, the method corresponds to the computer device 1 as shown in FIG. 1 and comprises the step of:

Step 30: using a processing unit 11 to read an instant message program 14 from a memory unit 13 and executing the instant message program 14, and displaying a visual operation interface 2 of the instant message program 14 at the display unit 12, and transmitting a user ID information to an instant message platform 15 to complete a logon procedure, and uploading the current network connection related data of the computer device 1 to the instant message platform 15;

Step 31: downloading the network connection related data of a computer device operated by a friend at a remote end and logged on the instant message platform 15 from the instant message platform 15, and performing a node-to-node connection in the instant message network 151 with a computer device operated by the friend at a remote end according to the network connection related data;

Step 32: using a global positioning module 10 to obtain the current position information of the computer device 1;

Step 33: transmitting the position information of the computer device 1 to the computer device operated by the friend at a remote end through the instant message network 151;

Step 34: receiving the position information of the computer device 16 operated by the friend at a remote end through the instant message network 151;

Step 35: displaying the position information of the computer devices operated by the user and the friend at a remote end at the map display area 21.

The computer device operated by the friend at a remote end is preferably a handheld computer device or an automobile computer device.

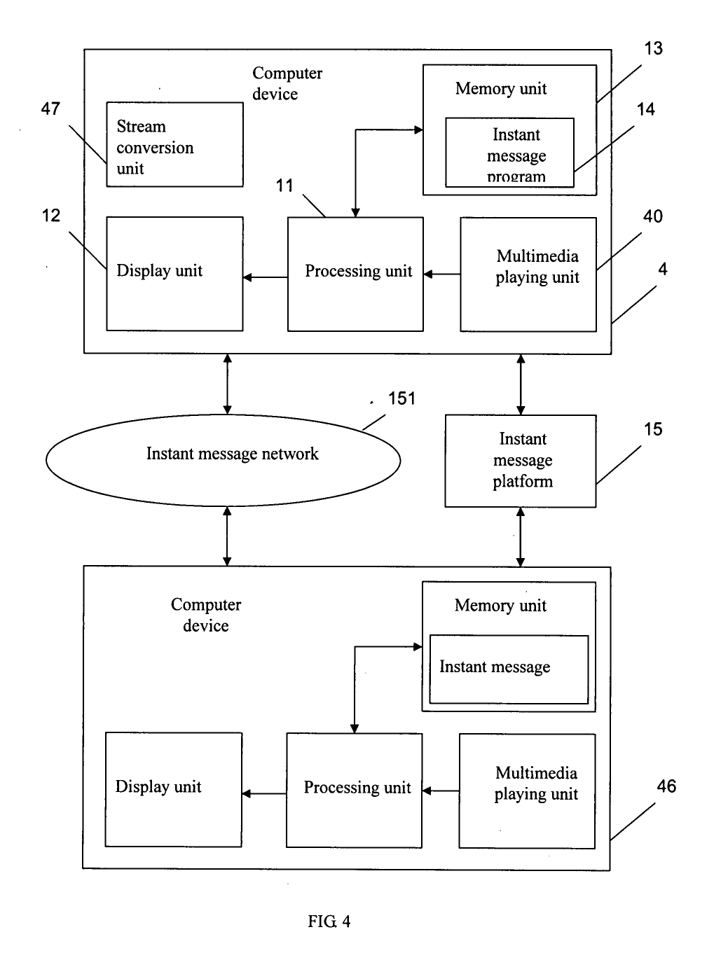

Referring to FIG. 4 for a block diagram of an apparatus provided for a user to share multimedia data with a friend at a remote end by an instant message in accordance with a preferred embodiment of the present invention, a user can use the electronic apparatus to share multimedia data with a friend at a remote end by the instant message. In FIG. 4, the computer device 4 is an embodiment of an electronic apparatus of the present invention and comprises a multimedia playing unit 40, a processing unit 11, a display unit 12, a memory unit 13 and a stream conversion unit 47. The multimedia playing unit 40 is provided for playing a multimedia file or a stream data, and the multimedia file can be a video file, an animation file or an audio file. The processing unit 11 is provided for reading an instant message program 14 from the memory unit 13 and executing the instant message program 14. A user ID information then is transmitted to an instant message platform 15 to complete a logon procedure. After the logon is completed, the instant message program 14 will store the current network connection related data such as an IP address or a port ID of the computer device 4 in the instant message platform 15 and provide the network connection related data to be read by another computer device at a remote end. Similarly, if a friend of the user is using a computer device 46 logged on the instant message platform 15, the computer device 4 will perform a node-to-node connection with a computer device 46 in an instant message network 151 for data transmissions according to the network connection related data of the computer device 46 stored in the instant message platform 15.

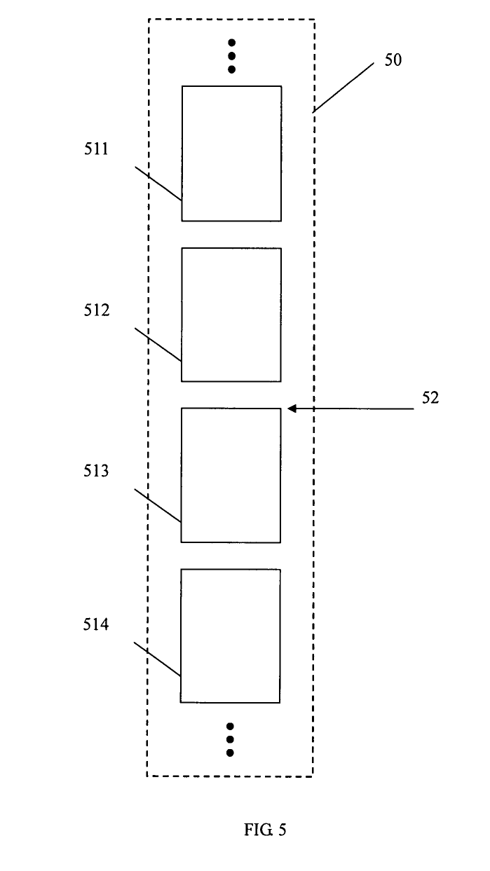

If the multimedia playing unit 40 is playing a video file as shown in FIG. 5 and the video file 50 is composed of a plurality of frames (such as frames 511, 512, 513, 514), then the multimedia playing unit 40 will play the video file 50 in a speed of 15˜30 frames per second to display the frames on the display unit 12. After the user views the frame 512 and shares the following video data with friends, a trigger signal can be generated by using a mouse to click a predetermined button of an interface of the multimedia playing unit 40. After the processing unit 11 receives the trigger signal, a stream conversion unit 47 is driven to convert the video data of the video file 50 after a point of the time 52 into video stream, and the multimedia stream is transmitted to the computer device 46 through the instant message network 151. The computer device 46 identifies the format of the received video stream to determine which application program can play such video stream and remind the user. Since the video stream has the instant play characteristic, therefore the computer device 46 can play the received video stream while receiving the video stream. With the aforementioned process, friends at a remote end can view the video stream that follows the frame 512 together. If the bandwidth of the network is broad enough, then the friends at a remote end and the user can view the video data that follows the frame 512 simultaneously.

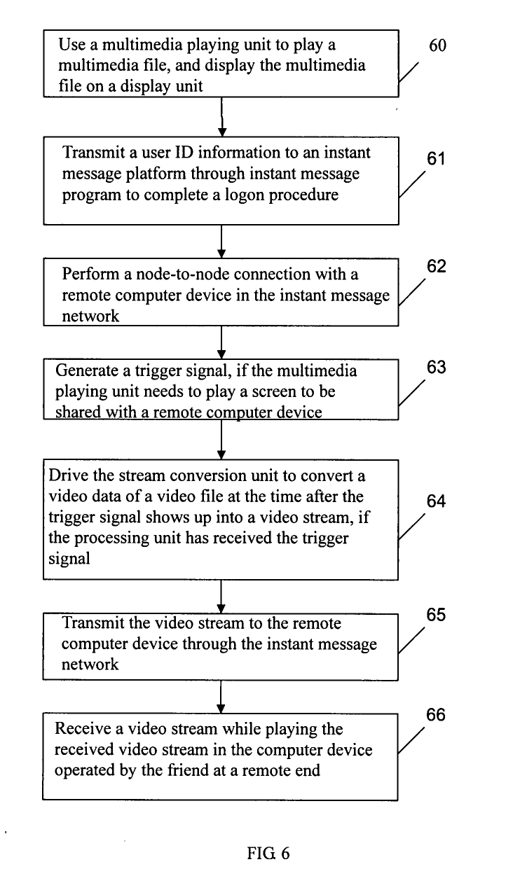

Referring to FIG. 6 for a flow chart of a method of sharing multimedia data between an electronic apparatus and a remote host in accordance with a preferred embodiment of the present invention, the method corresponds to the computer device 4 as shown in FIG. 4, and the method comprises the steps of:

Step 60: using a multimedia playing unit 40 to play a multimedia file, and displaying the multimedia file on a display unit 12;

Step 61: using a processing unit 11 to read an instant message program 14 from a memory unit 13, and transmitting a user ID information to an instant message platform 15 to complete a logon procedure, and uploading the current network connection related data of a computer device 1 to the instant message platform 15;

Step 62: downloading the network connection related data of a computer device 46 logged on the instant message platform 15 from the instant message platform 15, and performing a node-to-node connection of a computer device 46 operated by a friend at a remote end in the instant message network 151 according to the network connection related data;

Step 63: generating a trigger signal, if the multimedia playing unit 40 needs to play a screen to be shared with the friend at a remote end;

Step 64: driving the stream conversion unit 47 to convert video data of a video file 50 at the time after a trigger signal shows up into a video stream, if the processing unit 11 has received the trigger signal;

Step 65: transmitting the video stream to the computer device 46 through the instant message network 151;

Step 66: receiving a video stream while playing the received video stream in the computer device 46 operated by the friend at a remote end.

In Step 66, the format of a received video stream will be identified if the computer device 46 has received a video stream, to determine which application program can play such video stream and remind the user.

While the invention has been described by means of specific embodiments, numerous modifications and variations could be made thereto by those skilled in the art without departing from the scope and spirit of the invention set forth in the claims.

What is claimed is:

1. A method of sharing a position information between an electronic apparatus and a remote host, comprising the steps of:
transmitting a user ID information to an instant message platform to complete a logon procedure through an instant message program;
transmitting data with a remote host logged on said instant message platform through an instant message network;
obtaining a position information of said remote host, and transmitting a position information of an electronic apparatus of said user ID information to said remote host through said instant message network;
receiving said position information of said remote host through said instant message network; and
displaying said position information of said electronic apparatus and said remote host on an electronic map screen.

2. The method of claim 1, wherein said obtaining step further comprises the step of:
providing the position information of said remote host by a global positioning module

3. The method of claim 1, further comprising the steps:
selecting said remote host on said electronic map screen as a destination, and calculating a planned route between said electronic apparatus and said remote host.

4. The method of claim 3, wherein said electronic map screen displays said planned route.

5. The method of claim 3, further comprising:
providing a navigation message according to said planned route and said position information of said electronic apparatus, and said navigation message comprising a left turn message, a right turn message, a front gate reminding message, a speed limit reminder message or a police detector position reminding message.

6. The method of claim 1, wherein said instant message program is a Skype program, a MSN program or other software telephone program.

7. The method of claim 1, wherein said remote host is a handheld computer device or an automobile computer device.

8. An electronic apparatus, comprising:
a global positioning module for providing a position information of said electronic apparatus;
a processing unit for executing an instant message program, and transmitting a user ID information of said electronic apparatus to an instant message platform to complete a logon procedure, and transmitting a position information and an instant text message with a remote host logged on said instant message platform through an instant message network; and
a display unit for displaying a visual operation interface of said instant message program, and said visual operation interface having a text input area and an electronic map display area, and said display unit displaying said position information of said electronic apparatus and said remote host in said electronic map display area.

9. The apparatus of claim 8, wherein said apparatus further comprises a navigation module for calculating a planned route between said electronic apparatus and said remote host and performing a navigation according to said planned route.

10. The apparatus of claim 8, wherein said planned route is displayed at said map display area.

11. The apparatus of claim 8, wherein said instant message program is a Skype program, a MSN program or other software telephone program.

12. The apparatus of claim 8, wherein said remote host is a handheld computer device or an automotive computer device.

13. The apparatus of claim 8, further comprising a navigation module for calculating a planned route between said electronic apparatus and said remote host.

14. The apparatus of claim 13, wherein said electronic map display area is said planed route.

15. The apparatus of claim 13, wherein said navigation module generates a navigation message according to said planned route and said position information of said electronic apparatus, and said navigation message comprises a left turn message, a right turn message, a front gate reminding message, a speed limit reminder message or a police detector position reminding message.

16. A storage apparatus for storing a plurality of programs readable by a multimedia processing apparatus, and the steps performed by said multimedia processing apparatus based on said plurality of programs comprising:
transmitting a user ID information to an instant message platform to complete a logon procedure through an instant message program;
transmitting data with a remote host logged on said instant message platform through an instant message network;
obtaining a position information of said remote host;
transmitting a position information of an electronic apparatus of said user ID information to said remote host through said instant message network;
receiving a position information of said remote host through said instant message network; and
displaying position information of said electronic apparatus and said remote host on an electronic map screen.

17. The storage apparatus for storing a plurality of programs readable by a multimedia processing apparatus of claim 16, further comprising:
calculating a planed route between said electronic apparatus and said remote host.

18. The storage apparatus for storing a plurality of programs readable by a multimedia processing apparatus of claim 16, further comprising
displaying said planned route on said electronic map screen.

19. The storage apparatus for storing a plurality of programs readable by a multimedia processing apparatus of claim 16, further comprising:
generating a navigation message according to said planned route and said position information of said electronic apparatus, and said navigation message comprising a left turn message, a right turn message, a front gate reminding message, a speed limit reminder message or a police detector position reminding message.

20. A method of sharing multimedia data between an electronic apparatus and a remote host, comprising the steps of:
playing a multimedia file;
transmitting a user ID information to an instant message platform to complete a logon procedure through an instant message program;
transmitting data with a remote host logged on said instant message platform through an instant message network;
receiving a trigger signal;
converting a data of said multimedia file at the time after said trigger signal shows up into a multimedia stream;
transmitting said multimedia stream to said remote host through said instant message network; and
playing said multimedia stream at said remote host.

21. The method of claim 20, wherein said instant message program is a Skype program, a MSN program or other software telephone program.

22. The method of claim 20, wherein said multimedia file is a video file, an animation file or an audio file.

23. The method of claim 20, wherein said step of playing said multimedia stream at said remote host further comprises a step of identifying the format of said multimedia stream to determine whether or not application programs are capable of playing said multimedia video stream.

24. An electronic apparatus, comprising:
a multimedia playing unit;
a processing unit for executing an instant message program, and transmitting a user ID information of said electronic apparatus to an instant message platform to complete a logon procedure, and transmitting data with said remote host logged on said instant message platform through an instant message network; and
a stream conversion unit;
wherein if said multimedia playing unit is playing a multimedia file and said processing unit has received a trigger signal, then said processing unit will drive said stream conversion unit to convert a data of said multimedia file at the time after said trigger signal shows up into a multimedia stream, and said multimedia stream is transmitted to said remote host through said instant message network.

25. The apparatus of claim 24, wherein said instant message program is a Skype program, a MSN program or other software telephone program.

26. The apparatus of claim 24, wherein said multimedia file is a video file, an animation file or an audio file.

27. A storage apparatus for storing a plurality of programs readable by a multimedia processing apparatus, and the steps performed by said multimedia processing apparatus based on said plurality of programs comprising:
playing a multimedia file;
transmitting a user ID information to an instant message platform to complete a logon procedure;
transmitting data with a remote host logged on said instant message platform through an instant message network;
receiving a trigger signal;
converting data of said multimedia file at a time after said trigger signal shows up into a multimedia stream; and
transmitting said multimedia stream to said remote host through said instant message network.

28. The storage device for storing a plurality of programs readable by a multimedia processing apparatus of claim 27, wherein said multimedia file is a video file, an animation file or an audio file.
